(19) United States
(12) Patent Application Publication
(10) Pub. No.: US 2018/0026460 A1
(43) Pub. Date: Jan. 25, 2018

(54) CHARGER FOR A PORTABLE BATTERY POWERED DEVICE AND A MOBILE PHONE CASE

(71) Applicant: Jumpstart Technology Limited, Middlesex (GB)

(72) Inventors: Chaim Aaron James Green, London (GB); Michael David Jaeger, Middlesex (GB); Baruch Gad Alexander Coutts, London (GB); Dov Levy, London (GB)

(73) Assignee: Jumpstart Technology Limited, Middlesex (GB)

(21) Appl. No.: 15/548,184

(22) PCT Filed: Feb. 2, 2016
(86) PCT No.: PCT/GB2016/050232

§ 371 Date: Aug. 2, 2017

(30) Foreign Application Priority Data
Feb. 2, 2015 (GB) 1501651.2
Feb. 2, 2015 (GB) 1501720.5

(51) Int. Cl. H02J 7/00; H04M 1/02

(52) U.S. Cl. CPC H02J 7/0045; H02J 7/0054; H04M 1/0262; H02J 2007/0062; H04M 2001/0204

(57) ABSTRACT

A charger (100) for a portable battery powered device comprises a generally planar body (102). The body (102) comprises apertures (104a, 104b) for removably receiving and holding two batteries; contacts (110a, 110b) for engaging with terminals of each battery; a circuit (114) housed within the body (102) and coupled to at least a pair of the contacts (110b), the circuit (114) being configured to convert a voltage of the batteries into a predetermined charging voltage; and a connector (116) extending from the body (102) for providing the charging voltage to a said portable battery powered device. Major dimensions of the charger (100) are less than 86 mm by 54 mm and a thickness of the charger (100) is less than 5 mm.

### FIELD OF THE INVENTION

This invention relates to a charger for a portable battery powered device and a mobile phone case. In particular, this invention relates to a charger for a mobile phone.

### BACKGROUND TO THE INVENTION AND PRIOR ART

Portable handheld devices, such as mobile phones, cameras and media players, are powered by batteries, which carry a finite amount of charge. Over recent years there has been a continual drive to reduce the size and weight of these devices. At the same time, the functionality of these devices has increased and hand-in-hand with this increase in functionality has been an increase in the power consumption of these devices. This is particularly the case for mobile phone handsets, and particularly smart phones, whose capabilities have become more akin to that of personal computers. Consequently, one of the problems which many users of smart phones encounter is the need to balance the use of the phone with a limited battery capacity, and this can often lead to the batteries of such handsets losing their charge to the extent that the handsets no longer function.

The present invention provides a solution to this problem.

### SUMMARY OF INVENTION

According to a first aspect of the invention there is provided a charger for a portable battery powered device, the charger comprising: a mobile phone case body for receiving a mobile phone, the body comprising means for removably receiving and holding one or more batteries; contacts for engaging with terminals of the or each battery; a circuit housed within the body and coupled to at least a pair of the contacts, the circuit being configured to convert a voltage of the battery or batteries into a predetermined charging voltage; and a connector extendable from the body for providing the charging voltage to a said portable battery powered device. According to a second aspect of the invention there is provided a mobile phone case comprising: a body for receiving a mobile phone, the body comprising means for removably receiving and holding one or more batteries; contacts for engaging with terminals of the or each battery; a circuit housed within the body and coupled to at least a pair of the contacts, the circuit being configured to convert a voltage of the battery or batteries into a predetermined charging voltage; and a connector extendable from the body for providing the charging voltage to a said portable battery powered device. According to a further aspect of the invention there is provided a charger for a portable battery powered device, the charger comprising a generally planar body, the body comprising means for removably receiving and holding one or more batteries; contacts for engaging with terminals of the or each battery; a circuit housed within the body and coupled to at least a pair of the contacts, the circuit being configured to convert a voltage of the battery or batteries into a predetermined charging voltage; and a connector extending from the body for providing the charging voltage to a said portable battery powered device, wherein major dimensions of the charger are less than 86 mm by 54 mm and a thickness of the charger is less than 5 mm. The means for removably receiving the one or more batteries may comprise one or more aperture or cut-out. When the battery or batteries are received in the charger or case, portions of the battery extend beyond planar external faces of a wall in which the aperture or cut-out are disposed. The or each aperture may have opposed longitudinal walls comprising the means for holding the battery.

The means for holding the battery may comprises a strip or discrete portions of compressible material mounted along at least part of one or both of the opposed longitudinal walls.

The means for a holding the battery may be a partially or fully split strip or a U-shaped strip. The means for holding the battery may be made of rubber.

A separation between edges of the means for holding the battery may be less than a diameter or thickness of a said battery.

The body may comprises: a frame defining a cavity for receiving the said one or more batteries; a PCB tray mounted to an end of the frame for holding the circuit; and a circuit cover. Alternatively, the frame and PCB tray may be formed as a single part. The or each battery may be cylindrical.

In use, an axis of the or each battery may lie in the same plane as the body.

The or each battery may be an AA, a AAA or a C-type battery or another type of battery.

The charger or case may be adapted to receive and hold two batteries.

The portable battery powered device may be a mobile phone, i.e., the charger may be a mobile phone charger.

According to a further aspect of the invention there is provided a charger for a portable battery powered device, the charger being adapted to be arranged in a first, stowed configuration and in a second, deployed configuration, wherein: in the first configuration the charger is substantially flat; and in the second configuration the charger is adapted to hold and electrically couple with one or two batteries, the or each battery having a height greater than its diameter or width.

In the stowed configuration the major dimensions of the charger may be less than 86 mm by 54 mm.

The charger or case may further comprise an electrical connector for connection to said portable battery powered apparatus. According to a further aspect of the invention there is provided a mobile phone charger which is adapted to receive and electrically couple with two AA type batteries and which has major dimensions of less than 86 mm by 54 mm and a thickness of less than 5 mm. The thickness may preferably be less than 4 mm. The thickness may preferably be less than 3 mm.

According to a further aspect of the invention there is provided a battery powered mobile phone charger which is dimensioned such that it is insertable into a credit card slot of a wallet or purse and when inserted into the credit card slot less than 20% of the overall volume of the charger protrudes from the slot.

According to a further aspect of the invention there is provided a charger for a portable battery powered apparatus, the charger comprising: a body having two apertures, each aperture: being adapted to removably receive a cylindrical battery; having electrical contacts at its ends; and being lined at least partially along its longitudinal edges with compressible material for holding said battery in the aperture, a DC-DC converter circuit housed within the body and coupled to a pair of the contacts; and a device connector extending from the body and coupled to the output of the DC-DC converter circuit.

The charger or case may further comprise a rechargeable power cell for providing charge when no battery is received in the charger. The rechargeable power cell may be a rechargeable battery. The charger or case may further comprise means for connecting the charger to a USB power source.

According to a further aspect of the invention there is provided a kit of parts comprising: a charger or case as described above and one or more battery.

The kit of parts may further comprise a mobile phone.

According to a further aspect of the invention there is provided a case for a mobile phone, the case comprising means for receiving a charger as described above. The means for receiving a charger may be an aperture in the case.

When the charger is disposed in the aperture in the case the charger may substantially close the aperture to form a wall of the case.

The means for receiving the charger may substantially corresponds to the shape of the charger to provide a push-fit or compression fit arrangement to hold the charger in the case.

The charger or case described above is powered by batteries, such as AA or AAA batteries. The alternative to using this charger to charge portable devices is to use a mains powered device to charge the portable device. Such a mains powered device may be a dedicated charger, such as a charger for a mobile phone, a USB (RTM) port of a computer or a USB socket found in some dual power/USB mains sockets. Since these devices typically use transformers to transform mains (210/240 V rms AC) to 5 V DC, they are very inefficient. Conversely, since the present device merely transforms 3 V DC to 5 V DC then it is more efficient than mains powered portable device transformers. In addition, since rechargeable batteries can be used to power the charger of the present invention, and since there are widely available solar powered battery chargers, the present invention can be used to charge portable devices, such as mobile phones, without needing to use the main power supply whatsoever. Both of these advantages of the present invention provide environmentally friendly solutions to charging portable devices, such as mobile phones.

### BRIEF DESCRIPTION OF THE DRAWINGS

The invention will be further described by way of example with reference to the accompanying drawings in which:

FIG. 1 is a perspective view of a charger in accordance with a first embodiment of the invention;

FIG. 2 is a schematic diagram of a circuit forming part of the charger of FIG. 1;

FIG. 3 is a perspective view of a charger in accordance with a second embodiment of the invention;

FIG. 4 is a perspective view of a frame forming part of the charger of FIG. 3;

FIG. 5 is a perspective view of a PCB tray forming part of the charger of FIG. 3;

FIG. 6 is a perspective view of a circuit cover forming part of the charger of FIG. 3;

FIG. 7 is a perspective view of the PCB tray of FIG. 5 fixed into the frame of FIG. 4 and also including battery gripping strips;

FIG. 8 is a perspective view of the charger of FIG. 3 with the circuit cover removed;

FIG. 9 is a perspective view of a charger in accordance with a third embodiment of the invention;

FIGS. 10 and 11 are perspective views of an alternative arrangement for holding batteries in a charger embodying the invention;

FIGS. 12A-B show cross sectional profiles of rubber grommet which may be used to hold a battery in apertures of the chargers;

FIG. 13 is a perspective view of a case for a mobile phone in accordance with an embodiment of the invention and incorporating a charger as a removable part of a wall of the case; and

FIG. 14 is a perspective view of a case for a mobile phone in accordance with an embodiment of the invention and incorporating a charger as described above.

### DETAILED DESCRIPTION OF THE DRAWINGS

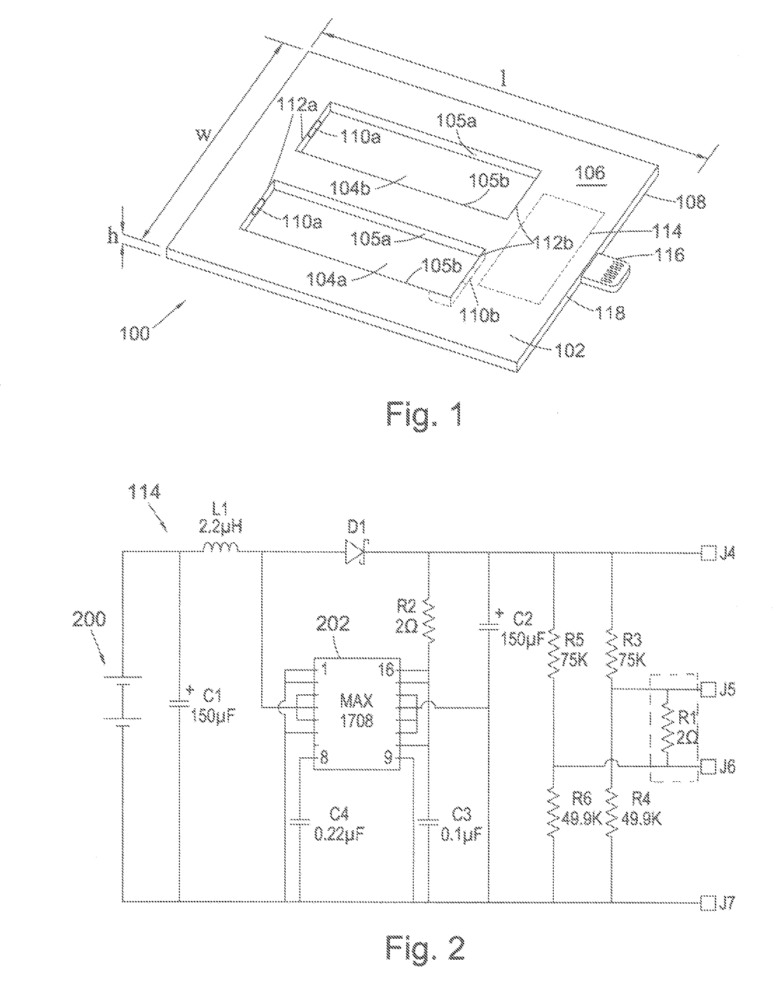

FIG. 1 shows a charger 100 for a portable battery powered device in accordance with a first embodiment of the invention. The charger 100 comprises a substantially rectangular planar body 102. The body 102 comprises two apertures 104a, 104b which pass from an upper face 106 of the body 102 to a lower face 108 thereof. Other than the two apertures 104a, 104b, each of the upper face 106 and the lower face 108 are substantially flat, having no portion which protrudes significantly from the surface. As is described below, this makes the charger 100 readily insertable into a small space, such as a credit card compartment of a wallet or purse.

Each aperture 104a, 104b is rectangular and has overall major dimensions similar to those of a cylindrical battery. In the present embodiment each aperture 104a, 104b has overall major dimensions similar to those of an AA type battery. Sprung contacts/terminals 110a, 110b are provided at opposed ends 112a, 112b of each aperture 104a, 104b. The contacts are sprung to allow for variations in the length of the cylindrical batteries within the limits of their standard dimensions. The contacts 110a, 110b are made of an electrically conductive metal such as aluminium, copper or steel. The contacts 110a, 110b are made of a thin spring metal material which is folded so as to be compressible against ends of the battery.

Each aperture 104a, 104b and its associated contacts 110a, 110b are dimensioned to provide a snug compression fit for an AA type battery, such that when an AA type battery is inserted into the aperture 104a, 104b it is held in place along its opposed longitudinal sides by the interior opposed longitudinal walls 105a, 105b of the aperture 104a, 104b and at its ends between the contacts 110a, 110b.

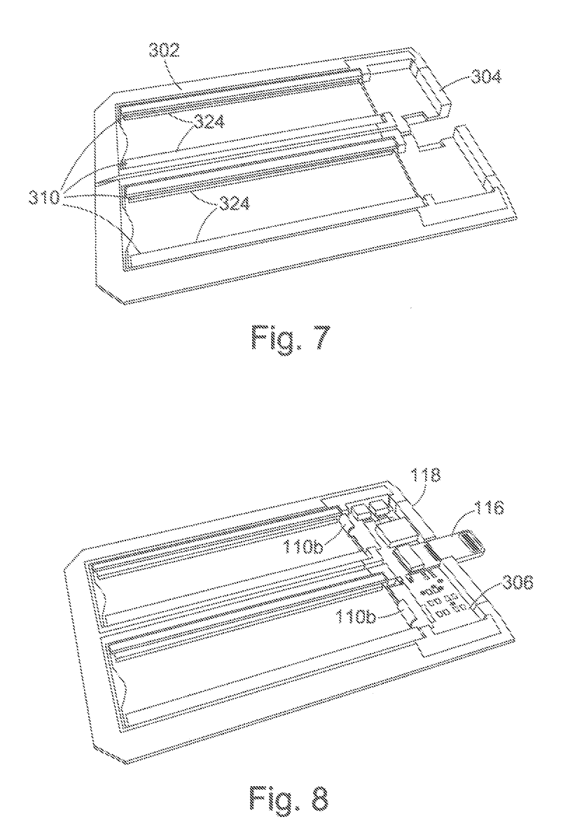

The width of each aperture 104a, 104b between the interior opposed longitudinal walls 105a, 105b is set to correspond to the diameter of an AA type battery. However, since the diameter of commercially available AA type batteries varies significantly, the interior longitudinal edges 105a, 105b of the apertures 104a, 104b may be lined with a strip of compressible rubber, which acts as a grommet, for receiving and holding the battery in place. This arrangement is shown in greater details in FIGS. 7 and 8. Alternatively, a plurality of strips of compressible rubber or a plurality of ‘spots’ of compressible rubber may be disposed along each interior longitudinal edge 105a, 105b of the apertures 104a, 104b. For example a split rubber grommet as shown in FIG. 12A or a U-shaped grommet as shown in FIG. 12B may be used, where the grommet is spread open when the battery is inserted into its aperture.

The contacts 110a, 110b are coupled by wiring (not shown) which is internal to the body 102 to a circuit, which is shown schematically at 114, which is also inside the body 102. Further details of the circuit are provided in relation to FIG. 2. The circuit 114 is further connected to a connector 116 which extends from one end 118 of the body 102. The electrical components may be connected by soldering, wiring or integrated tracking.

The overall dimensions of the charger 100 are such that it can be inserted into a credit card slot/compartment of a wallet or purse. The dimensions of a credit card are set by the international standard ISO/IEC 7810 under the ID-1 format as 85.60×53.98×0.76 mm. Consequently most wallets and purses include one or more slots to accommodate credit cards of these dimensions. In such wallets the slots are sometimes orientated ‘landscape’, whereby a longest edge of the credit card is inserted through the mouth of the slot, with the opposed longest edge protruding from the slot to allow a user to grip that edge prior to removing the card from the slot. In other wallets the slots are orientated ‘portrait’, whereby a shorter edge of the credit card is inserted through the mouth of the slot.

With reference FIG. 1, using the components described with reference to FIG. 2, the height h of the charger cannot be as low as 0.76 mm. Since the height h of the body 102 of the charger 100 is greater than the 0.76 mm specified in the above international standard then the length/and the width w will respectively be less than the 85.60×53.98 mm specified in the standard. In particular, the length/may be 85 mm, 84 mm, 83 mm, 82 mm or less and the width w may be 53 mm, 52 mm, 51 mm, 50 mm or less. Note that the length/includes the length of the body 102 and the length of the connector 116 which protrudes from the end 118 of the body 102, so that the charger 100 can be comfortably inserted into a card slot of a wallet or purse long edge first. FIG. 2 is a schematic diagram of the circuit 114 forming part of the charger 100 of FIG. 1.

The circuit 114 is a DC-DC converter which converts an input voltage provided by a pair of AA type batteries 200, which together, when fully charged, provide a nominal voltage of around 3V. The circuit 114 is based around a MAX1708 chip 202 which is manufactured by Maxim Integrated, Inc. The MAX 1708 chip 202 is a step-up DC-DC converter which is capable of delivering up to 10 W of power at a fixed (3.3V or 5V) or adjustable (2.5V to 5.5V) output, using an on-chip power MOSFET from a 0.7V to 5V supply. A particular advantage of using this chip 200 is its small size, having a low profile, which is ideally suited to a charger which is to be fitted into a card slot of a wallet or purse.

In the embodiment described below, the components of the circuit (other than resistors R1 and R3 to R6) are chosen to produce a 5V output at a current of 0.5 A. This output voltage and current is a common current and voltage used to charge mobile phones, including iPhones (RTM) and other phones which require a micro-USB (RTM) connector. As is explained below, resistors R1 and R3 to R6 have the function of providing the appropriate voltages on connector pads J5 and J6 to allow the charger 100 to be used to charge specific mobile phones or other portable battery powered devices.

The components chosen to configure the MAX1708 chip 202 to provide a 5V output at connector pad J4 are as follows:
CI—input bypass capacitor of 150 μP—to regulate the current in conjunction with the MAX1708 chip 202.
C2—Output filter capacitor of 150 μP—to regulate the current in conjunction with the MAX1708 chip 202.
C4—capacitor of 0.22 μP for converter MAX1708 chip 202 reference pin 8.

D1 Schottky diode for current regulation.

LI Inductor of 2.2 pH for charging the MAX1708 chip 202.

C3 capacitor 150 μP, and R2—resistor of 2Ω—C3 and R2 activate the MAX 1708 chip 202 and are connected to pins 10, 15 and 16 thereof.

R3—resistor of 75KΩ,

R4—resistor of 49.9KΩ,

R5—resistor of 75KΩ, and

R6—resistor of 49.9KΩ—R3, R4, R5 and R6 provide a pair of voltage dividers for data pins of iPhone. The voltage dividers are chosen to each provide voltages on connector pads J5 and J6 of 2V. When the charger 100 is used with an Apple (RTM) Lightning (RTM) connector to charge an iPhone, applying a voltage of 2V to the two data pins in this way set the iPhone to draw current at 0.5 A. NB When the charger is used to charge a phone using a micro-USB device, resistor R1 (shown within a broken line is not required) is required but resistors R3, R4, R5 and R6 are not required.

R1—resistor of 2Ω—R1 is only used when R3 to R6 are not required, e.g., for charging micro-USB devices. R1 is used to bridge connector pads J5 and J6 to supply 5V to any USB device at +,− output pins.

The MAX 1708 chip 202 demands a very specific layout both in proximity of certain components to certain pins on it and track width to allow necessary current flow and heat dissipation. The MAX1708 chip 202 also demands components with certain specifications, hence the choice of CI, C2, Dl and LI. For the present embodiment of the invention in order to provide a low profile charger 100 the components are chosen based on their ability to match the requirements of the MAX1708 chip 202 and their low physical profile.

The components of the circuit 112 are coupled to the MAX 1708 chip 202 by surface mounting the components and the MAX 1708 chip 202 on a PCB. In order to reduce the overall height of the circuit 112 the thickness of the PCB should be as small as possible and a PCB of thickness 0.2 mm has been used for this purpose.

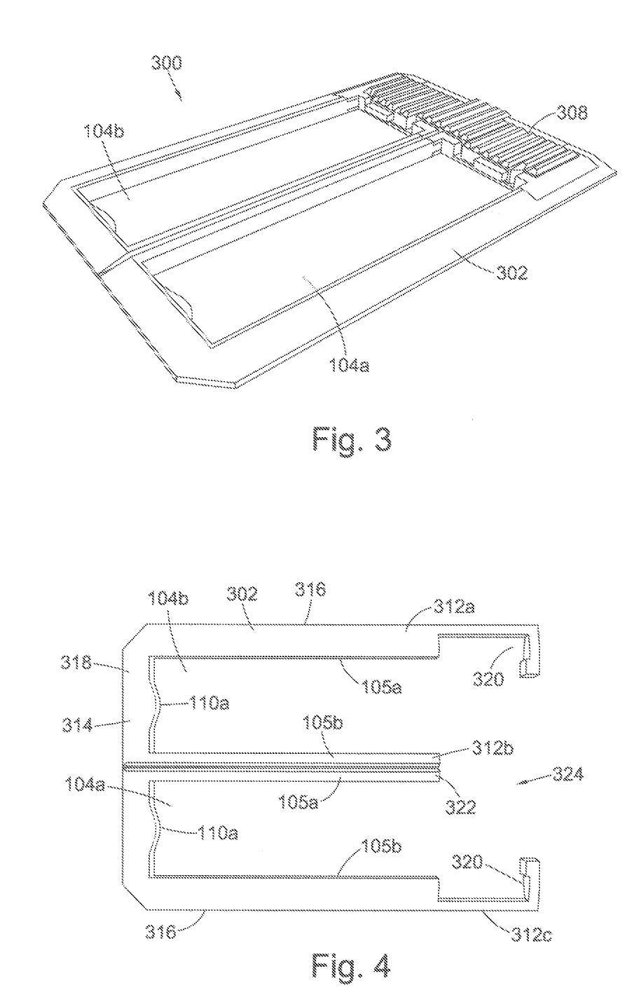

As stated above, the components are chosen to provide a stable output voltage of 5V at connector pad J4. In other embodiments where a voltage other than 5V is required at connector pad J4 components having different values are to be used. As can be seen from FIG. 2, pin 7 of the MAX 1708 chip 202 is floating. This pin has the function of limiting the current which the MAX 1708 chip 202 draws. There may optionally be connected between this pin and the ground rail a resistor in order to limit the input current Imaxdrawn by the MAX 1708 chip 202. The value of the resistor is set according to the formula R=312×Imax/5. Therefore, to set the value of Imax at 0.5 A a resistor of 32Ω is used. Alternatively, to set the value of Imaxas 0.8 A and 1 A, a resistor of 49.9Ω and 63Ω respectively can be used. FIG. 3 is a perspective view of a charger 300 in accordance with a second embodiment of the invention. Further details of some of the components of the charger 300 can be seen in FIGS. 4 to 8.

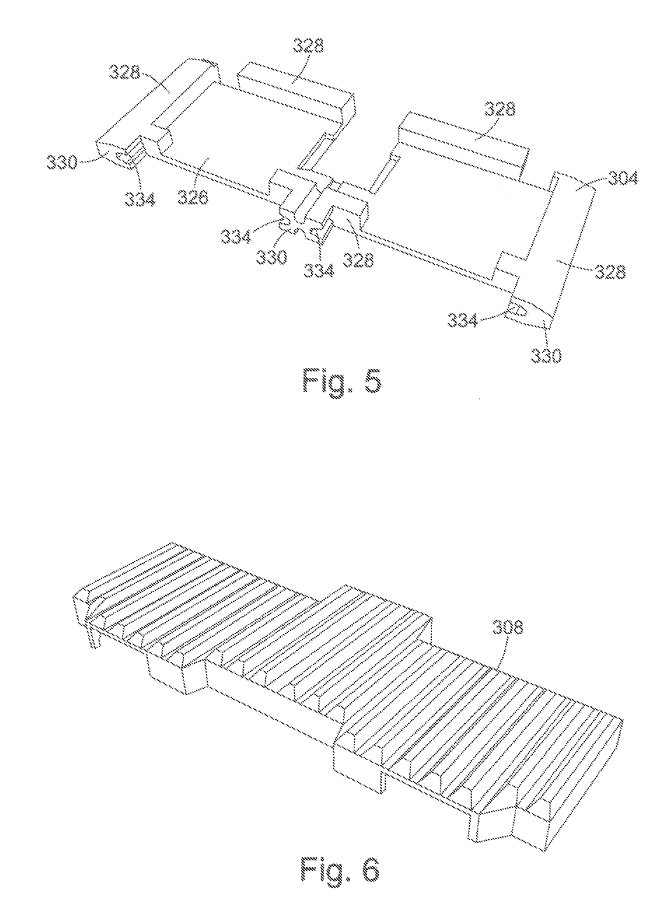

The charger 300 has a similar structure to the charger 100 shown in FIG. 1 and the same reference numerals are used for the same parts. The charger 300 comprises a frame 302 (shown in FIG. 4), a PCB tray 304 (shown in FIG. 5), a PCB 306, a circuit cover 308 (shown in FIG. 6) and battery gripping strips 310 (omitted from FIG. 3 and shown in FIGS. 7 and 8). The frame 302 is generally ‘M’ shaped, comprising three prongs 312a, 312b, 312c which extend from a roof part 314. A cavity 104a, 104b is defined between each of the outer two prongs 312a, 312c and the central prong 312b for receiving two A A type batteries. The central prong 312b is shorter than the outer two prongs 312a, 312c and a cut-out 320 is formed in each of the outer two prongs 312a, 312c beyond an end 322 of the central prong 312b, to define a cavity 324 to receive the PCB tray 304. As can be seen in FIGS. 7 and 8, the interior opposed longitudinal walls 105a, 105b have mounted thereon battery gripping strips 310. The battery gripping strips 310 are made of a resiliency compressible material, such as rubber. To mount the battery gripping strips 310 the interior opposed longitudinal walls 105a, 105b of the prongs have a groove (not shown) for receiving part of the battery gripping strips 310. Alternatively or additionally the battery gripping strips 310 may be glued or otherwise fixed to the interior opposed longitudinal walls 105a, 105b. In order to allow the charger 300 to be easily inserted into a card compartment of a wallet or purse in a landscape orientation, the longitudinal edges 316 of the outer two prongs 312a, 312c are tapered. Similarly, in order to allow the charger 300 to be easily inserted into a card compartment in a portrait orientation, the end edge 318 of the roof part 314 is also tapered.

As with the charger 100 of FIG. 1, each aperture 104a, 104b formed between the battery gripping strips 310 is rectangular and has an overall dimension similar to an AA type battery. In particular, the distance between the inner edges 324 of the battery gripping strips 310 is less than the diameter of an AA type battery. To install a battery in an aperture 104a, 104b, the battery is pushed into the aperture 104a, 104b to compress the resiliency compressible battery gripping strips 310, so that the battery is firmly held between opposed battery gripping strips 310. Sprung contacts/terminals 110a are provided at the roof part 314 end of each aperture 104a, 104b. In the present embodiment the frame 302 is made of conducting material and the contacts 110a are integrally formed in the frame 302. In other embodiments the contacts 110a may be electrically isolated from the frame 302, for example where the frame 302 is made of a non-electrically conducting material and internal wiring is provided to interconnect the contacts 110a.

FIG. 5 is a perspective view of the PCB tray 304 and FIG. 7 shows the PCB tray 304 in situ in the frame 302. The PCB tray 304 has a tray base 326 surrounded by a number of flange portions 328. Protrusions 330 on the side 332 of the PCB tray 304 are aligned with the prongs 312a, b, c when the PCB tray 304 is mounted in the frame 302. The protrusions 330 are provided with grooves 334 for receiving a portion of the battery gripping strips 310, and these grooves 334 align with the grooves (not shown) in the interior opposed longitudinal walls 105a, 105b of the prongs 312a, 312b, 312c. This can be seen in FIG. 7 where the battery gripping strips 310 run along the interior opposed longitudinal walls 105a, 105b of the prongs 312a, 312b, 312c and continue into the grooves 334 of the protrusions 330 of the PCB tray 304.

FIG. 8 is a perspective view of the charger 300 of FIG. 3 with the circuit cover 308 removed. This Figure shows the parts of FIG. 7 and additionally with the PCB 306 installed in the PCB tray 304. The PCB 306 is provided with spring contacts 110b which couple the batteries into the circuit 114. As with the charger 100 of FIG. 1, a connector 116, which is mounted on the PCB 306, extends from an end 118 of the body beyond the frame 302. The circuit cover 308 is shown in FIG. 6 and this is mounted over the PCB 306 in the assembled charger 300, as shown in FIG. 3. During operation of the charger 300 a relatively large current (around 0.5 A) passes through the circuit 114 and this amount of current can produce heat. The circuit cover 308, when mounted on the PCB, is in contact with some of the components of the circuit 114, for example the MAX1708 chip 202 and additionally functions as a heat sink. As can be seen in FIG. 8, the circuit cover 308 has a ribbed upper surface. As well as the ribbed surface providing the charger 300 with an aesthetically pleasing appearance and assisting with the gripping of the charger 300 whilst being removed from a wallet, the increased area provided by the ribbed surface increases the heat transfer efficiency of the cover 308. In other embodiments the circuit cover 308 is not ribbed, which provides a lower profiled charger 300.

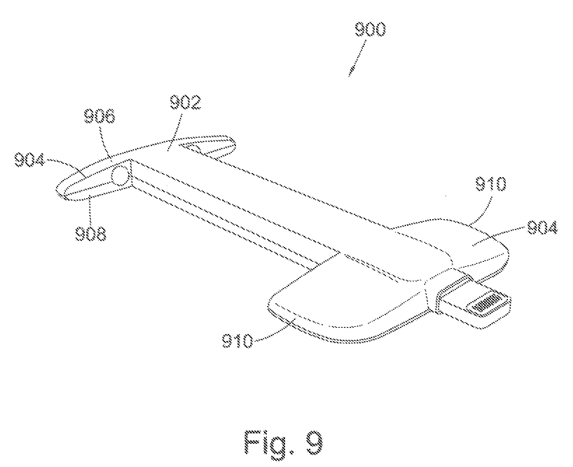

FIG. 9 shows a charger 900 forming a third embodiment of the invention. The charger 900 of FIG. 9 is similar to the charger 300 shown in FIGS. 3 to 8, other than the shape of its body 902 which is I-shaped, having cut-outs in its sides. This configuration of the charger 900 allows the batteries to be inserted through the sides of the charger 900 rather from only above or below the body 902 of the charger. In this configuration the batteries are held in compression between ends 904 of the I-shaped body 902. The charger 900 of FIG. 9 includes the circuit 114 as shown in FIG. 2, as do all embodiments of this invention.

In the embodiment of FIG. 9 as with the embodiment of FIGS. 3 to 8, the charger 900 is generally planar, however its upper face 906 and lower face 908 are curved convexly. In other words, unlike the charger 100 of FIG. 1 the charger 300 of FIG. 9 does not have flat upper 906 and lower 908 faces. Having curved upper 906 and lower 908 faces means that the longitudinal edges 910 of the charger 900 have a lower height than the height of the body along its centre line, where higher components described with reference to FIG. 2 may be located. The lower edge height means that the charger 900 is readily insertable into a card slot of a wallet or purse along its longitudinal edge.

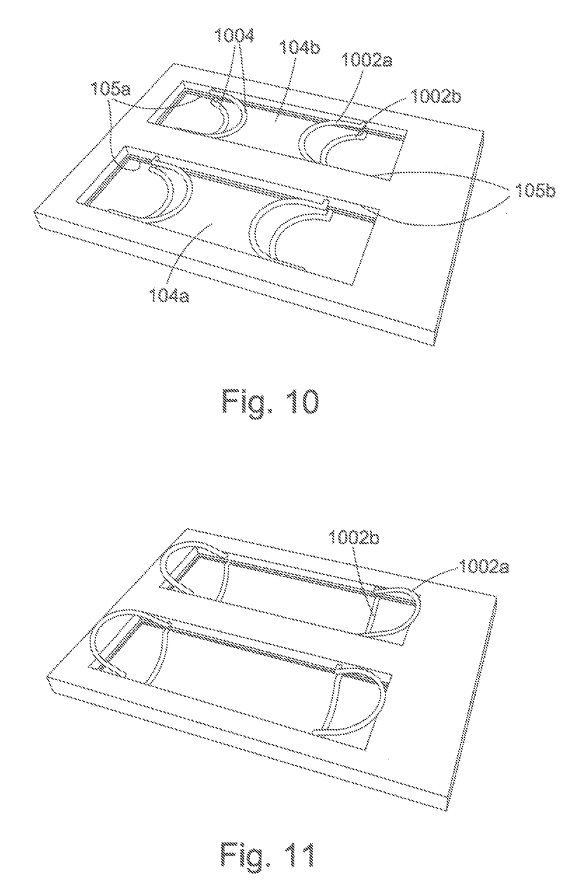

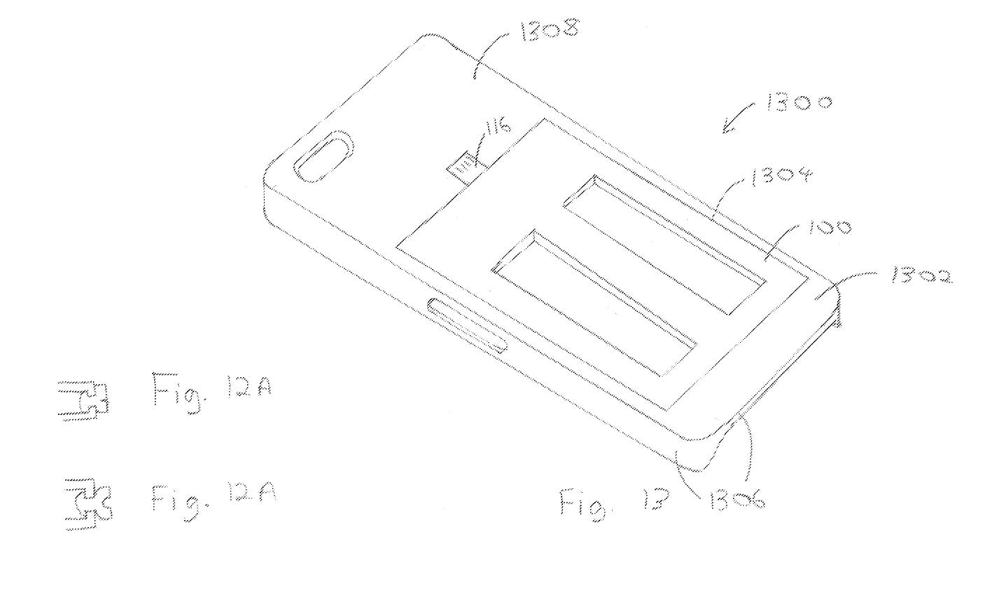

FIGS. 10 and 11 show an alternative arrangement for removably receiving and holding a pair of AA type batteries in a charger. Note that the connector for connecting the charger to a mobile phone is omitted in these Figures. To receive and hold the batteries each aperture 104a, 104b is provided with two pairs of wire retainers 1002a, 1002b. One pair of wire retainers 1002a, 1002b is provided at each end of each aperture 104a, 104b. Each wire retainer 1002a, 1002b has a central portion 1004 which is generally semi-circular. Extending from each end of the central portion 1004 are axle portions, so that each wire retainer 1002a, 1002b has a general Ω-shape. The axle portions are inserted into recesses in the interior opposed longitudinal walls 105a, 105b of the apertures 104a, 104b, so that each wire retainer 1002a, 1002b pivots around its axle portions in the apertures 104a, 104b.

As can be seen from FIGS. 10 and 11, an upper wire retainer 1002a of each pair of wire retainers 1002a, 1002b pivots upwards and the other lower wire retainer 1002b pivots downwards. The central portion 1004 of the upper wire retainer 1002a extends further than the central portion 1004 of the lower wire retainer 1002b.

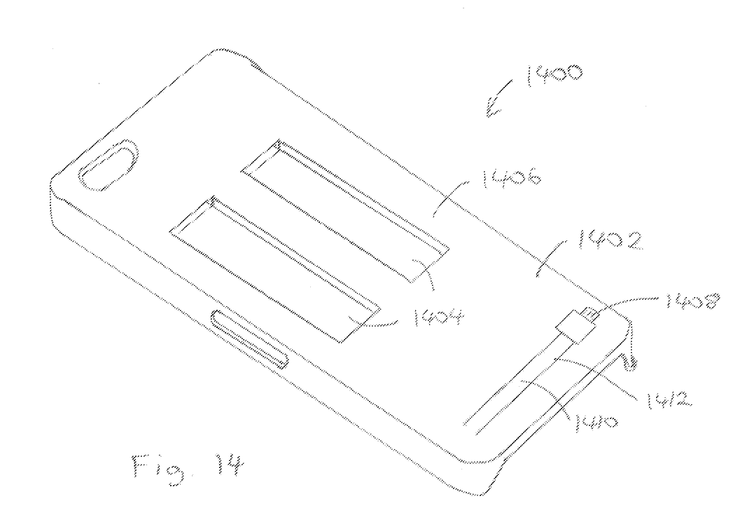

FIG. 10 shows the means for removably receiving and holding the batteries in a first configuration. In this configuration the wire retainers 1002a, 1002b are in their stowed position and the charger is substantially flat. To insert and hold a battery into the charger the wire retainers 1002a, 1002b at each end of each aperture 104a, 104b are rotated outwards as shown in FIG. 11. In particular, the lower wire retainers 1002b are rotated to their lowermost position, where the central portion 1004 is perpendicular to the charger body and the upper wire retainer 1002a is rotated fully so that the central portion 1004 abuts the body. When the upper wire retainers 1002a are in their fully extended position a battery is inserted into the space between the upper retainers 1002a to rest on the lower retainers 1002b. Once the battery is in this position the upper wire retainers 1002a are rotated towards each other to pass over the ends of the battery to a position above the battery, so that the charger is in a second configuration in which the charger receives and electrically couples with the batteries. FIG. 13 is a perspective view of a case 1300 for a mobile phone. The case 1300 comprises a body 1308 and a charger 100 as a removable part of a wall of the case 1300. The body 1308 comprises a major wall 1304 and four partial or full side walls 1306 (two of which are visible in FIG. 13) which extend perpendicularly from the major wall 1302 of the case 1300.

The major wall 1302 of the case 1300 has an aperture 1304 which is dimensioned to correspond to the major dimensions of the charger 100. Due to the similarity of the dimensions of the aperture 1304 and the charger 100, the charger 100 is held in place in the aperture 1304 by a snug compression fit. In the region of the connector 116 of the charger 100, the aperture 1304 may be oversized, so that there is no compression fit between the walls of the aperture 1304 and the connector 116, so that when the charger 100 is removed from the case 1300 the connector 116 will not snag in any way on the body 1308, thereby avoiding the risk of putting strain on the connector 116 when the charger 100 is removed from the body 1308.

In other embodiments of the case invention the charger the case may be arranged to form a continuous wall around the major wall of a mobile phone with partial or complete walls around the four peripheral walls of the phone, and the charger may be insertable into a cavity in the major wall.

FIG. 14 is a perspective view of a case 1400 for a mobile phone incorporating a charger as described above as a further embodiment of the invention. The case 1400 of FIG. 14 has a similar overall shape as the case 1300 of FIG. 13. However, the case 1400 of FIG. 14 does not include a charger which is removable from the body 1402 of the case 1400. Rather, apertures 1404 for batteries are formed in a major wall 1406 of the case 1400 and the case 1400 includes a connector 1408 which is connected to circuitry which is housed internally in the case 1400 by a flexible cable 1410. The case 1400 includes a cavity 1412 (which may be a through aperture or a recess) to receive and hold the cable 1410 and connector 1408 in a stowed configuration. In order to use the case 1400 to charge a mobile phone or other portable device the case 1400 is removed from the mobile phone which it normally protects, the cable 1410 and connector 1408 are removed from the cavity 1412 and connected to the device which is to be charged, and batteries are inserted into the battery apertures 1404 in order to power the circuitry, which in turn provides the suitable current and voltage to the connector 1408.

As with each of the previous embodiments, the case/charger 1400 may incorporate a power cell, such as a rechargeable battery or other electrical storage cell, to be able to charge the portable device when no batteries are inserted in the battery apertures 1404, such that the batteries when inserted into the battery apertures 1404 will charge the internal cell and the device to which the connector 1408 is connected. Various modifications will be apparent to those in the art and it is desired to include all such modifications as fall within the scope of the accompanying claims.

For example, in the embodiments described above the chargers are powered by AA type battery, otherwise know as the Mignon or IEC-LR6 battery. In other embodiments of the invention the charger may be powered by other batteries. In other embodiments, the charger is powered by other cylindrical batteries such as AAA or CR2032 batteries. Where non-AA batteries are used, the apertures are dimensioned appropriately to receive such batteries. Furthermore, non-cylindrical batteries, such as the PP3 9V battery may be used. A particular advantage of AA type batteries is that they are the most widely available batteries.

In the embodiments described above, two AA batteries, each providing a nominal voltage of between 1.2 and 1.65 V (depending on the type) are used. In other embodiments, a single AA battery (or other cylindrical battery as described above) can be used. However, it has been found that in order to provide a voltage of a suitable current over the required period of time it is preferable to use two AA batteries, which are preferably fully charged.

Furthermore, for the chargers described with reference to FIGS. 1 to 9, the connector 116 extends from the end 118 of the body 102, 302 so that the length of the body is no more than the length of a credit card. In other embodiments the connector may be connected to the rest of the charger by a flexible cable which may normally be stored within the body of the charger, or by a wound cable, or by a flat wire that slides in or out, such that when the charger is deployed the connector 118 is pulled out of the body 102 and positioned at an appropriate height to be inserted into the device to be charged.

In the embodiments described above, the chargers are powered by one or more battery. In other embodiments the charger may additionally have a connector for connection to a USB (RTM) port of a computer or mains charger. The connector may be fixed to the body of the charger or it may be connected by a cable, which provides some flexibility between the connector and the body of the charger. The connector may be retractable within the body of the charger. An advantage of providing the charger with a USB connector is that the charger can be charged either from a USB port or, when the user is remote from a USB port, by one or more battery.

In the embodiment described with reference to FIGS. 1 to 8, the charger 100 includes a PCB tray 304 which is inserted into a frame 302. In other embodiments the PCB tray forms part of the frame as single component.

In the embodiments described above a MAX1708 chip 202 is used as the basis for the DC-DC converter. It is envisaged that other chips can be used to provide this function. In the embodiment of FIG. 13, the charger 100 is removed from the body 1308 of the case 1300 by pushing the charger 100 out perpendicularly from the plane of the major wall 1302. In other embodiments of the case, the aperture may descend to one end of the case so that the charger can be slid out of the case in the same direction as the plane of the major wall 1302.

1-34. (canceled)

35. A charger for a portable battery powered device, the charger comprising:
a generally planar body, the body comprising means for removably receiving and holding one or more batteries;
contacts for engaging with terminals of the or each battery;
a circuit housed within the body and coupled to at least a pair of the contacts, the circuit being configured to convert a voltage of the battery or batteries into a predetermined charging voltage; and
a connector extending from the body for providing the charging voltage to a said portable battery powered device,
wherein major dimensions of the charger are less than 86 mm by 54 mm and a thickness of the charger between first and second major faces of the charger is less than 5 mm.

36. A charger as claimed in claim 35, wherein the means for removably receiving the one or more batteries comprises one or more aperture or cut-out.

37. A charger as claimed in claim 35, wherein the or each aperture has opposed longitudinal walls comprising the means for holding the battery.

38. A charger as claimed in claim 35, wherein the means for holding the battery comprises a strip or a plurality of discrete portions of compressible material mounted along at least part of one or both of the opposed longitudinal walls.

39. A charger as claimed in claim 35, wherein the means for a holding the battery is a partially or fully split strip or a U-shaped strip.

40. A charger as claimed in claim 38, wherein the means for holding the battery is made of rubber.

41. A charger as claimed in claim 37, wherein a separation between opposed edges of the means for holding the battery is less than a diameter or thickness of a said battery.

42. A charger as claimed in claim 35, wherein the body comprises:
a frame defining an aperture for receiving the said one or more batteries;
a PCB tray mounted to an end of the frame for holding the circuit; and
a circuit cover.

43. A charger as claimed in claim 35, wherein the means for removably receiving and holding one or more batteries is configured to receive and hold one or more respective battery which is cylindrical.

44. A charger as claimed in claim 43, wherein, in use, a major axis of the or each battery lies in the same plane as the body.

45. A charger as claimed in claim 35, wherein the means for removably receiving and holding one or more batteries is configured to receive and hold one or more respective AA, a AAA or a C-type battery.

46. A charger as claimed in claim 35, wherein the charger is adapted to receive and hold two batteries.

47. A charger as claimed in claim 35, wherein the portable battery powered device which the charged is configured to charge is a mobile phone.

48. A charger as claimed in claim 35, further comprising a rechargeable power cell for providing charge when no battery is received in the device.

49. A charger as claimed in claim 48, wherein the rechargeable power cell is a rechargeable battery.

50. A charger as claimed in claim 35, further comprising means for connecting the device to a USB power source.

51. A charger as claimed in claim 35, further comprising one or more battery.

52. A charger as claimed in claim 35, further comprising a case for a mobile phone, the case comprising means for receiving said charger.

53. A mobile phone charger which is adapted to receive and electrically couple with two AA type batteries and which has major dimensions of less than 86 mm by 54 mm and a thickness of less than 5 mm.

54. A charger for a portable battery powered device, the charger being adapted to be arranged in a first, stowed configuration and in a second, deployed configuration, wherein:
in the first configuration the charger is substantially flat; and
in the second configuration the charger is adapted to hold and electrically couple with one or two batteries, the or each battery having a height greater than its diameter or width.
